(19) United States
(12) Patent Application Publication
(10) Pub. No.: US 2010/0229411 A1
(43) Pub. Date: Sep. 16, 2010

(54) FOLDABLE MEASURING DEVICE

(75) Inventor: Ying Wu Lai, Miauli (TW)

Correspondence Address: CHARLES E. BAXLEY, ESQUIRE, 90 JOHN STREET, SUITE 309, NEW YORK, NY, 10038, US

(73) Assignee: Cheng Lin WANG

(21) Appl. No.: 12/381,706

(22) Filed: Mar. 16, 2009

(51) Int. Cl. B43L 7/10

(52) U.S. Cl. 33/458

(57) ABSTRACT

A foldable measuring device includes a number of segments pivotally connected together with pivot axles, one segment includes a recess and an aperture for receiving a pivot axle, the other segment includes a protrusion for engaging with the recess of the other segment and includes an orifice for receiving the pivot axle, a spring biasing member is engaged into the other segment and engaged with the pivot axle for biasing the segments toward each other, and a cover segment is attached to the other segment for covering and shielding and protecting the spring biasing member, and for preventing the spring biasing member from being exposed and damaged by the other segment.

### BACKGROUND OF THE INVENTION

1. Field of the Invention

The present invention relates to a foldable measuring rule or tool or device, and more particularly to a foldable measuring device including a simplified structure for allowing the foldable measuring device to be made with a simplified manufacturing and assembling procedure and with a reduced manufacturing cost.

2. Description of the Prior Art

Typical foldable measuring rules or tools or devices comprise two or more segments pivotally or rotatably coupled together to form a compact fording structure for storing and transportation purposes, and the segments may also be opened or unfolded for measuring purposes.

For example, U.S. Pat. No. 832,483 to Johnson, U.S. Pat. No. 840,628 to Johnson, U.S. Pat. No. 999,725 to Adams, U.S. Pat. No. 1,643,033 to Schvetz, and U.S. Pat. No. 5,020,233 to Syken disclose five of the typical folding rules or measuring instruments each also comprising two or more segments pivotally or rotatably coupled together with joints or pivot axles.

However, the pivotally coupled segments are solidly coupled together with the joints or pivot axles such that the segments may not be slightly separated from each other, and the segments should be formed with notches or depressions for allowing the segments to be folded relative to each other.

U.S. Pat. No. 7,111,408 to Critelli et al. discloses another typical folding rule or measuring instrument comprising a number of segments pivotally or rotatably connected together with joints or pivot axles, and a biasing element may help urge one segment against the adjacent segment by acting on the pivot joints or pivot axles.

However, the biasing element will be exposed and may be contacted with or interfered by the adjacent segments, and thus may have a good chance to be bent or folded or damaged by the adjacent segments.

The present invention has arisen to mitigate and/or obviate the afore-described disadvantages of the conventional foldable measuring devices.

### SUMMARY OF THE INVENTION

The primary objective of the present invention is to provide a foldable measuring device including a simplified structure for allowing the foldable measuring device to be made with a simplified manufacturing and assembling procedure and with a reduced manufacturing cost.

In accordance with one aspect of the invention, there is provided a foldable measuring device comprising a plurality of segments pivotally connected together with pivot axles to assume a collapsed configuration and an extended configuration, and the segments each including a length indicating indicium provided thereon, and the segments including a first segment and a second segment adjacent to each other, the first segment including a recess formed therein, and an aperture formed therein and communicative with the recess thereof for receiving the pivot axle, the second segment including a protrusion extended therefrom for selectively engaging with the recess of the first segment, and including an indentation formed therein and located opposite to the protrusion, and including an orifice formed therein for receiving the pivot axle, a spring biasing member engaged into the indentation of the second segment and engaged with the pivot axle, for forcing and biasing the first and the second segments toward each other when the first and the second segments are separated from each other and when the protrusion of the second segment is disengaged from the recess of the first segment, and a cover segment attached to the second segment for covering the indentation of the second segment and for shielding and protecting the spring biasing member and the pivot axle, and for preventing the spring biasing member from being exposed.

The second segment includes a depression formed therein and communicative with the indentation of the second segment for receiving the cover segment. The cover segment is preferably flush with the second segment.

The second segment includes a cavity formed therein and communicative with the indentation of the second segment for forming at least one platform in the second segment and for engaging with the spring biasing member. The cavity of the second segment is defined by at least one inclined surface.

The spring biasing member includes a hole formed therein for receiving the pivot axle, and the pivot axle includes an enlarged head having an outer diameter greater than an inner diameter of the hole of the spring biasing member for engaging with the spring biasing member.

The cover segment includes an opening formed therein and aligned with the enlarged head of the pivot axle for partially receiving the enlarged head of the pivot axle and for partially exposing the enlarged head of the pivot axle, and for allowing the enlarged head of the pivot axle to be seen by the users.

The second segment includes at least one hole formed therein, and the cover segment includes at least one pin extended therefrom for engaging with the hole of the second segment and for securing to the second segment.

The recess of the first segment is a longitudinal recess, and the protrusion of the second segment is a longitudinal protrusion for engaging with the longitudinal recess of the first segment and for spacing the segments from each other when the segments are rotated relative to each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a foldable measuring device in accordance with the present invention;

FIG. 2 is a partial perspective view of the foldable measuring device;

FIG. 3 is a partial plan schematic view of the foldable measuring device;

FIG. 4 is a partial cross sectional view of the foldable measuring device taken along lines 4-4 of FIG. 3;

FIG. 5 is a partial plan schematic view similar to FIG. 3, illustrating the operation of the foldable measuring device; and

FIG. 6 is a partial cross sectional view of the foldable measuring device taken along lines 6-6 of FIG. 5.

### DETAILED DESCRIPTION OF THE PREFERRED EMBODIMENT

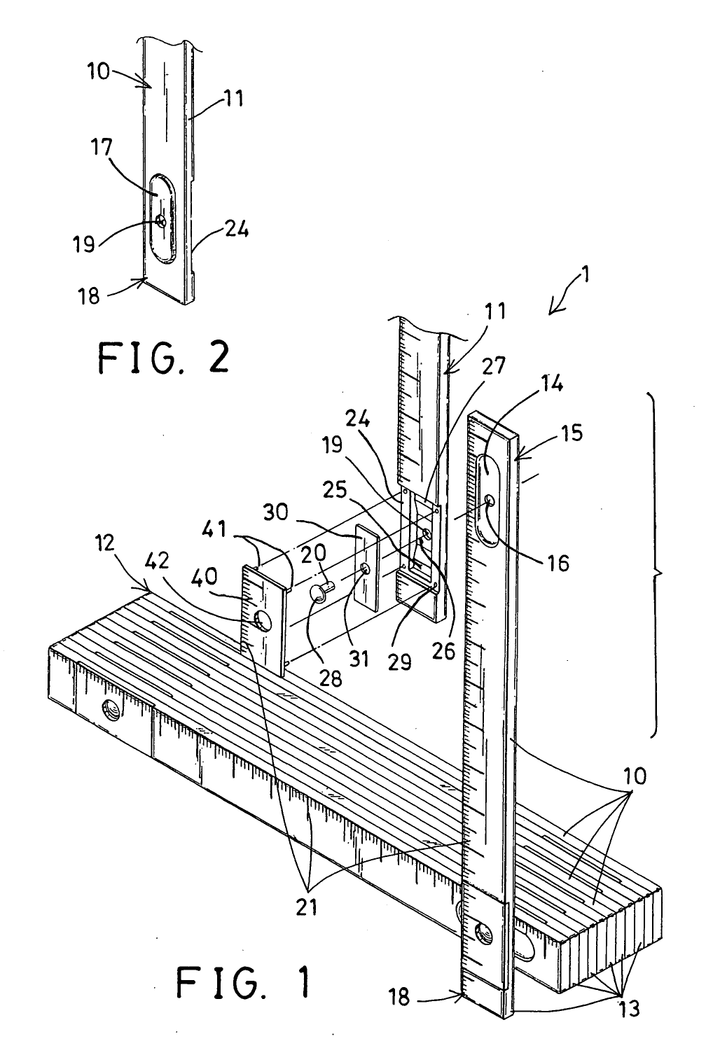

Referring to the drawings, and initially to FIGS. 1-4, a foldable measuring device 1 in accordance with the present invention comprises a number of segments 10 pivotally or rotatably connected together with joints or pivot axles 20, the pivoting action of the segments 10 allows the foldable measuring device 1 to assume a collapsed or stacked configuration for storing and transportation purposes, and an extended configuration for measuring purposes. For ease of reference, the segments 10 may include two end segments 11, 12, and a number of intermediate segments 13 pivotally coupled together with the joints or pivot axles 20.

The segments 10 of the foldable measuring device 1 are preferably made of rubber, plastic, or other synthetic materials, and include length indicating indicia 21 provided on the segments 10, such as inches, centimeters, or any other useful linear distance scale known in the art. Advantageously, length indicating indicia 21 are present on both side of the segments 10 with the respective scales incrementing in opposite directions. The above-described structure is typical and will not be described in further details.

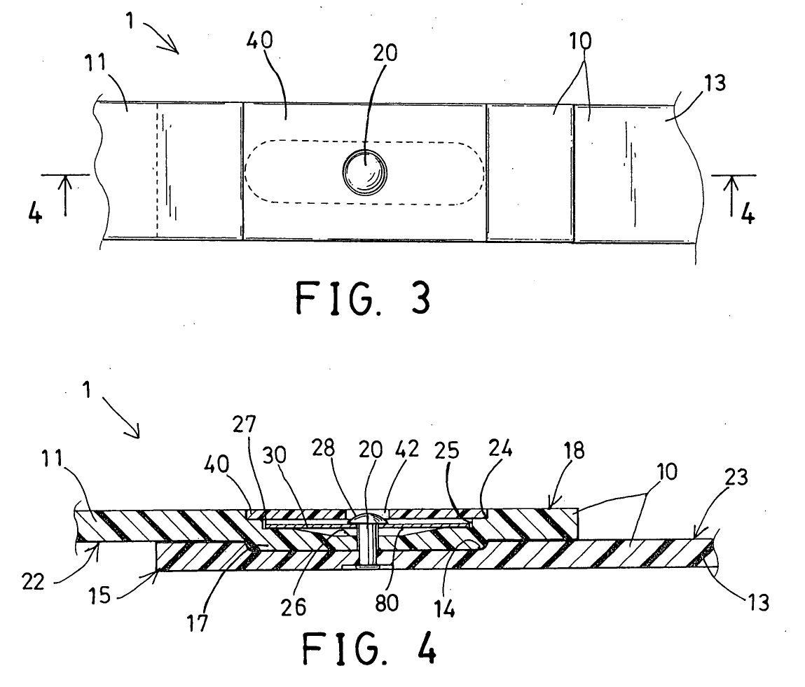

The intermediate segments 13 and one of the end segments 12 each include an oblong hole or longitudinal recess 14 formed in one end portion 15 thereof, and an aperture 16 also formed in the one end portion 15 thereof and communicative with the recess 14 thereof for receiving the joints or pivot axles 20. The other end segment 11 and the intermediate segments 13 each include an oblong or longitudinal swelling or protrusion 17 extended outwardly from the other end portion 18 of the respective segment 11, 13 for engaging with the respective recesses 14 of the other segments 13, 12 (FIGS. 3-6).

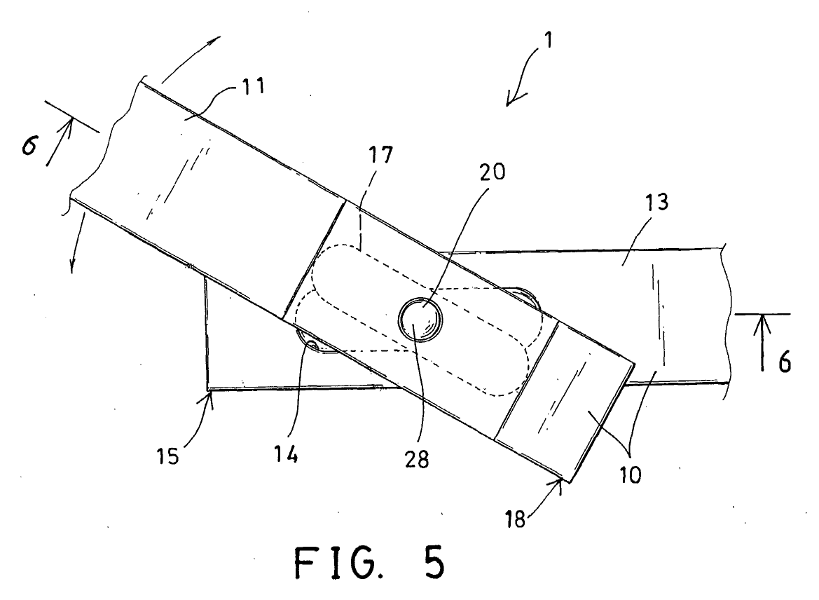

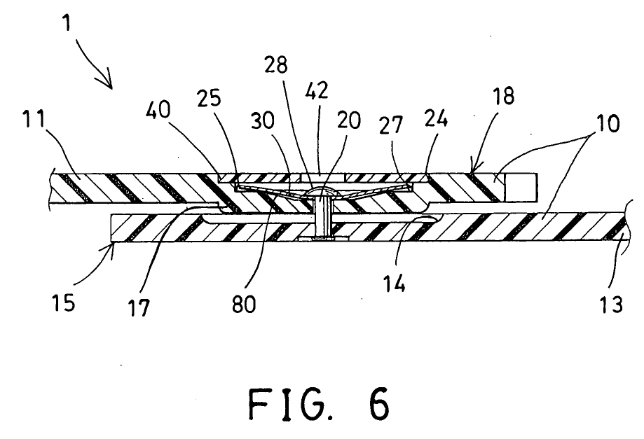

As shown in FIGS. 3-4, when the two adjacent segments 11, 13 are aligned or in-line with each other, and when the protrusion 17 of one segment 11 is engaged into the respective recess 14 of the other segment 13, the adjacent surfaces 22, 23 of the two adjacent segments 11, 13 may be closely contacted or engaged with each other. When the two adjacent segments 11, 13 are offset or rotated relative to each other with or about the pivot axle 20, as shown in FIGS. 5-6, the protrusion 17 of one segment 11 will be disengaged from the recess 14 of the other segment 13 and inclined relative to the recess 14 of the other segment 13, and the adjacent surfaces 22, 23 of the two adjacent segments 11, 13 will be disengaged or separated from each other for allowing the two adjacent segments 11, 13 to be rotated relative to each other to the required angular directions.

The segments 11, 13 each further include a depression 24 formed in the other end portion 18 thereof and formed or located opposite to the protrusion 17, and each further include an indentation 25 also formed in the other end portion 18 thereof and having an area smaller than that of the depression 24 and communicative with the depression 24 thereof, and each further include a cavity 26 also formed in the other end portion 18 thereof and having an area smaller than that of the indentation 25 for forming two opposite or spaced platforms 27, and each further include an orifice 19 also formed in the other end portion 18 thereof and communicative with the cavity 26 thereof and aligned with the aperture 16 of the other segments 13, 12 for receiving the joints or pivot axles 20. It is preferable that the cavity 26 of the segments 11, 13 is defined by one or more (such as two) inclined or tapered or tilted surfaces 80 (FIGS. 4, 6).

A spring biasing member 30 is engaged into the indentation 25 of the segments 11, 13 and engaged with the platforms 27, and preferably include a size or area or dimension equals to or no greater than that of the indentation 25 of the segments 11, 13 for allowing the spring biasing member 30 to be suitably fitted or engaged into the indentation 25 of the segments 11, 13 and to be suitably engaged with the platforms 27, and arranged for allowing the spring biasing member 30 to be suitably bent or curved. The spring biasing member 30 includes a hole 31 formed therein for receiving the pivot axle 20, and the pivot axle 20 includes an enlarged head 28 having an outer diameter greater than the inner diameter of the hole 31 of the spring biasing member 30 for engaging with the spring biasing member 30 and for allowing the spring biasing member 30 to be suitably bent or curved by the pivot axle 20 when the protrusion 17 of one segment 11 is disengaged from the recess 14 of the other segment 13 and when the two adjacent segments 11, 13 are offset or rotated relative to each other with the pivot axle 20.

A cover segment 40 is further provided and engaged with the depression 24 of the segments 11, 13 for covering or shielding or blocking the indentation 25 of the segments 11, 13, and for shielding or protecting the spring biasing member 30 and the pivot axle 20, and for preventing the spring biasing member 30 from being exposed, and thus for preventing the spring biasing member 30 from being bent or folded or damaged by the adjacent segments 13, 12. The cover segment 40 includes one or more (such as four) pins 41 extended outwardly therefrom for engaging with the corresponding holes 29 of the segments 11, 13 and for securing to the segments 11, 13. The pins 41 and/or the cover segment 40 may further be solidly secured to the segments 11, 13 with adhesive materials, welding processes or the like.

As shown in FIG. 1, the cover segment 40 also includes a length indicating indicium 21 provided thereon, and the cover segment 40 is preferably flush with the segments 11, 13, best shown in FIGS. 4, 6, and the cover segment 40 may further include an opening 42 formed therein and aligned with the enlarged head 28 and/or the pivot axle 20 for partially receiving the enlarged head 28 of the pivot axle 20 (FIG. 4) and for allowing the enlarged head 28 of the pivot axle 20 to be seen by the users.

In operation, as shown in FIGS. 3 and 4, the protrusion 17 of one segment 11 may be forced to engage into the respective recess 14 of the other segment 13 by the spring biasing member 30 when the two adjacent segments 11, 13 are aligned or in-line with each other, and the adjacent surfaces 22, 23 of the two adjacent segments 11, 13 may also be forced to closely contact or engage with each other by the spring biasing member 30. It is preferable that the spring biasing member 30 has not been bent or curved when the protrusion 17 of one segment 11 is engaged into the respective recess 14 of the other segment 13.

As shown in FIGS. 5 and 6, when the two adjacent segments 11, 13 are forced or moved away from each other, and/or when the two adjacent segments 11, 13 are rotated relative to each other, the protrusion 17 of one segment 11 will be disengaged from the recess 14 of the other segment 13, and the spring biasing member 30 may be suitably bent or curved to suitably force or bias the two adjacent segments 11, 13 toward each other, to allow the two adjacent segments 11, 13 to be rotated relative to each other to the required angular directions. It is to be noted that the spring biasing member 30 may be suitably shielded or protected by the cover segment 40 for preventing the spring biasing member 30 from being exposed, and for preventing the spring biasing member 30 from being bent or folded or damaged by the adjacent segments 13, 12.

Accordingly, the foldable measuring device in accordance with the present invention includes a simplified structure for allowing the foldable measuring device to be made with a simplified manufacturing and assembling procedure and with a reduced manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A foldable measuring device comprising:
a plurality of segments pivotally connected together with pivot axles to assume a collapsed configuration and an extended configuration, and said segments each including a length indicating indicium provided thereon, and said segments including a first segment and a second segment adjacent to each other,
said first segment including a recess formed therein, and an aperture formed therein and communicative with said recess thereof for receiving said pivot axle,
said second segment including a protrusion extended therefrom for selectively engaging with said recess of said first segment, and including an indentation formed therein and located opposite to said protrusion, and including an orifice formed therein for receiving said pivot axle,
a spring biasing member engaged into said indentation of said second segment and engaged with said pivot axle, for forcing and biasing said first and said second segments toward each other when said first and said second segments are separated from each other and when said protrusion of said second segment is disengaged from said recess of said first segment, and
a cover segment attached to said second segment for covering said indentation of said second segment and for shielding and protecting said spring biasing member and said pivot axle, and for preventing said spring biasing member from being exposed.

2. The foldable measuring device as claimed in claim 1, wherein said second segment includes a depression formed therein and communicative with said indentation of said second segment for receiving said cover segment.

3. The foldable measuring device as claimed in claim 1, wherein said cover segment is flush with said second segment.

4. The foldable measuring device as claimed in claim 1, wherein said second segment includes a cavity formed therein and communicative with said indentation of said second segment for forming at least one platform in said second segment and for engaging with said spring biasing member.

5. The foldable measuring device as claimed in claim 4, wherein said cavity of said second segment is defined by at least one inclined surface.

6. The foldable measuring device as claimed in claim 1, wherein said spring biasing member includes a hole formed therein for receiving said pivot axle, and said pivot axle includes an enlarged head having an outer diameter greater than an inner diameter of said hole of said spring biasing member for engaging with said spring biasing member.

7. The foldable measuring device as claimed in claim 6, wherein said cover segment includes an opening formed therein and aligned with said enlarged head of said pivot axle for partially receiving said enlarged head of said pivot axle.

8. The foldable measuring device as claimed in claim 1, wherein said second segment includes at least one hole formed therein, and said cover segment includes at least one pin extended therefrom for engaging with said at least one hole of said second segment and for securing to said second segment.

9. The foldable measuring device as claimed in claim 1, wherein said recess of said first segment is a longitudinal recess, and said protrusion of said second segment is a longitudinal protrusion for engaging with said longitudinal recess of said first segment.
